(19) United States
(12) Patent Application Publication
(10) Pub. No.: US 2023/0152109 A1
(43) Pub. Date: May 18, 2023

(54) Vehicle and Method for Controlling the Same

(71) Applicants: Hyuundai Motor Company, Seoul (KR); Kia Corporation, Seoul (KR)

(72) Inventor: Myung Kyun Shin, Daegu (KR)

(73) Assignees: Hyundai Motor Company, Seoul (KR); Kia Corporation, Seoul (KR)

(21) Appl. No.: 17/900,496

(22) Filed: Aug. 31, 2022

(30) Foreign Application Priority Data
Nov. 16, 2021 (KR) 10-2021-0158023

(51) Int. Cl. G01C 21/34; G01C 21/36

(52) U.S. Cl. CPC G01C 21/3469; G01C 21/3605

(57) ABSTRACT

An embodiment vehicle includes a battery, an input device, a display, and a processor configured to request input of destination information in response to receipt of an on instruction of a load power supply mode through the input device, obtain distance information from a current location to a destination based on current location information and the destination information in response to receipt of the destination information through the input device, obtain a required amount of power necessary for driving to the destination based on the obtained distance information, identify an amount of power charged in the battery, obtain an amount of discharge energy by supplying power to an external device based on the obtained required amount of power and the amount of power charged in the battery, and control the display to display the obtained amount of discharge energy as proposal information.

### CROSS-REFERENCE TO RELATED APPLICATIONS

This application claims the benefit of Korean Patent Application No. 10-2021-0158023, filed on Nov. 16, 2021, which application is hereby incorporated herein by reference.

### TECHNICAL FIELD

The disclosure relates to a vehicle and a method for controlling the same.

### BACKGROUND

A vehicle, a machine that travels a road by driving wheels, is equipped with various devices for protecting occupants, assisting in driving, and improving riding comfort.

Such vehicles include internal combustion engine vehicles that generate mechanical power by burning petroleum fuels such as gasoline and diesel and use the mechanical power to drive the vehicle and eco-friendly vehicles that are driven by electricity to reduce fuel consumption and harmful gas emissions.

Eco-friendly vehicles includes electric vehicles, hybrid vehicles, and hydrogen fuel cell vehicles. For example, the electric vehicles include a battery and a motor as a rechargeable power source and rotate the motor with electricity stored in the battery and drive wheels using the rotation of the motor. The hybrid vehicles include an engine, a battery, and a motor and drive by controlling mechanical power of the engine and electrical power of the motor.

As such, eco-friendly vehicles, when a battery plug of a vehicle is connected to a wired plug of a charger disposed in a parking lot or a charging station, receive external power and charge a battery using the supplied power.

Recently, developments of technology (e.g., Vehicle to Load (V2L)) for supplying electric power charged in a battery of an eco-friendly vehicle to an external device has been ongoing.

When the electric power charged in the battery is transferred to the external device through V2L, eco-friendly vehicles have difficulty in securing a driving distance to the destination as the battery is discharged.

In other words, when electric power charged in a battery of an eco-friendly vehicle is supplied to an external device, the vehicle becomes difficult to travel to a destination, leading to causing inconvenience of charging the battery before reaching the destination. Furthermore, when the electric power charged in the battery is supplied to the external device, users feel anxious because of the possibility of not securing a driving distance to the destination.

### SUMMARY

The disclosure relates to a vehicle and a method for controlling the same. Particular embodiments relate to a vehicle for supplying electric power from a vehicle battery to an external device and a method for controlling the same.

An embodiment of the disclosure provide a vehicle that proposes an amount of discharge energy for supplying a load based on destination information when a load power supply mode (i.e., a V2L mode) is performed, and a control method for the same.

Another embodiment of the disclosure provides a vehicle that obtains destination information based on event information stored in a terminal when the load power supply mode (i.e., the V2L mode) is performed and proposes an amount of discharge energy for supplying a load based on the obtained destination information, and a control method for the same.

Another embodiment of the disclosure provides a vehicle that searches for a charging station in response to an amount of discharge energy selected by a user being greater than an amount of discharge energy for supplying a load when the load power supply mode (i.e., the V2L mode) is performed, and a method for controlling the same.

Additional embodiments of the disclosure will be set forth in part in the description which follows and, in part, will be obvious from the description, or may be learned by practice of the disclosure.

In accordance with an embodiment of the disclosure, a vehicle includes a battery, an input device, a display, and a processor configured to request input of destination information in response to an on instruction of a load power supply mode being received through the input device, obtain distance information from a current location to a destination based on current location information and the destination information in response to the destination information being received through the input device, obtain a required amount of power necessary for driving to the destination based on the obtained distance information, identify an amount of power charged in the battery, obtain an amount of discharge energy by supplying power to an external device based on the obtained required amount of power and the amount of power charged in the battery, and control the display to display the obtained amount of discharge energy as proposal information.

The vehicle may further include a power transmission device to which a power transmission cable is connected and an on board charger (OBC) that converts a level of power of the battery and transmits the converted power to the power transmission device.

The processor may be further configured to determine whether the power may be supplied to the external device based on at least one of manipulation position information of a shift lever and mode information received through the input device, in response to the on instruction of the load power supply mode being received through the input device.

The processor may be further configured to determine that the load power supply mode may be executed in response to determining that the shift lever is positioned at a parking stage P based on the manipulation position information of the shift lever.

The processor may be further configured to determine that the load power supply mode may be executed in response to determining that an on instruction of a utility mode is received through the input device.

The processor may be further configured to control the display to display destination input request information for requesting the input of the destination information in response to determining that the load power supply mode may be executed.

The processor may be further configured to search for a route based on the current location information and the destination information, obtain distance information and fuel efficiency information for each type of road in the searched route based on route information on the searched route, and obtain the required amount of power based on the distance information and fuel efficiency information for each type of road in the searched route.

The vehicle may further include a communicator, wherein the processor is further configured to receive big data from a server through the communicator, obtain the fuel efficiency information in the searched route based on the received big data, and obtain the required amount of power based on the obtained fuel efficiency information.

The processor may be further configured to use a predetermined amount of margin power when obtaining the amount of discharge energy.

The vehicle may further include a communicator, wherein the processor is configured to, in response to determining that the destination information has not been received through the input device, attempt to communicate with a terminal through the communicator, and in response to communication with the terminal being performed, obtain event information from the terminal, and obtain the destination information based on the obtained event information.

The processor may be further configured to, in response to the amount of discharge energy received in the input device exceeding the obtained amount of discharge energy, search for a charging station based on the current location information and the destination information, and add the searched charging station as a waypoint.

The processor may be further configured to identify an amount of energy supplied to the external device and control termination of the load power supply mode in response to the identified amount of energy being the obtained amount of discharge energy.

The processor may be further configured to, in response to determining that the obtained amount of discharge energy is set as the amount of energy to be supplied to the external device, control termination of the load power supply mode when the amount of energy supplied to the external device becomes the obtained amount of discharge energy.

In accordance with another embodiment of the disclosure, a method of controlling a vehicle comprising a motor for generating a driving force by receiving power from a battery is provided. The method comprises requesting input of destination information in response to an on instruction of a load power supply mode being received through an input device, obtaining distance information from a current location to a destination based on current location information and the destination information in response to the destination information being received through the input device, obtaining a required amount of power necessary for driving to the destination based on the obtained distance information, identifying an amount of power charged in the battery, obtaining an amount of discharge energy by supplying power to an external device based on the obtained required amount of power, the amount of power charged in the battery, and a predetermined amount of margin power, and displaying the obtained amount of discharge energy as proposed information on a display.

The method may further include determining that the load power supply mode may be executed in response to determining that a shift lever is positioned at a parking stage P based on manipulation position information of the shift lever and displaying destination input request information for requesting the input of the destination information on the display in response to determining that the load power supply mode may be executed.

Obtaining the required amount of power may further include searching for a route based on the current location information and the destination information, obtaining distance information and fuel efficiency information for each type of road in the searched route based on route information on the searched route, and obtaining the required amount of power based on the distance information and fuel efficiency information for each type of road in the searched route.

Obtaining the required amount of power may further include searching for a route based on the current location information and the destination information, receiving big data from a server through a communicator, obtaining fuel efficiency information in the searched route based on the received big data, and obtaining the required amount of power based on the obtained fuel efficiency information.

The method may further include attempting to communicate with a terminal through a communicator in response to determining that the destination information has not been received through the input device, obtaining event information from the terminal in response to communication with the terminal being performed, and obtaining the destination information based on the obtained event information.

The method may further include, in response to the amount of discharge energy received in the input device exceeding the obtained amount of discharge energy, searching for a charging station based on the current location information and the destination information and adding the searched charging station as a waypoint.

The method may further include identifying an amount of energy supplied to the external device and controlling termination of the load power supply mode in response to the identified amount of energy being the obtained amount of discharge energy.

### BRIEF DESCRIPTION OF THE DRAWINGS

These and/or other embodiments of the disclosure will become apparent and more readily appreciated from the following description of the exemplary embodiments, taken in conjunction with the accompanying drawings, in which:

FIG. 1 is a view illustrating a vehicle according to an embodiment of the disclosure;

FIG. 2 is a configuration diagram illustrating a power system of a vehicle according to an embodiment of the disclosure;

FIG. 3 is a detailed configuration diagram illustrating a battery manager provided in a vehicle according to an exemplary embodiment of the disclosure;

FIG. 4 is a control configuration diagram illustrating a vehicle according to an embodiment of the disclosure;

FIG. 5 is a view illustrating a display of a vehicle according to an embodiment of the disclosure; and

FIG. 6 is a control flowchart illustrating control of a vehicle according to an exemplary embodiment of the disclosure.

### DETAILED DESCRIPTION OF ILLUSTRATIVE EMBODIMENTS

Like reference numerals refer to like elements throughout. The disclosure does not describe all elements of the embodiments such as overlap between the general contents and the embodiments in the technical field to which the disclosure belongs. This specification does not describe all elements of the exemplary embodiments of the disclosure and detailed descriptions on what are well known in the art or redundant descriptions on substantially the same configurations may be omitted. The terms ‘part, module, member, block’ used in the specification may be implemented in software or hardware, and a plurality of ‘parts, modules, members, blocks’ may be embodied as one component. It is also possible that one ‘part, module, member, block’ includes a plurality of components.

Throughout the specification, when an element is referred to as being “connected to” another element, it may be directly or indirectly connected to the other element and “indirectly connected to” includes being connected to the other element via a wireless communication network.

Furthermore, when a part is said to “include” a certain component, this means that it may further include other components, not to exclude other components unless otherwise stated.

Throughout the specification, when a member is located “on” another member, this includes not only when one member is in contact with another member but also when another member exists between the two members.

The terms first, second, etc. are used to distinguish one component from another component, and the component is not limited by the terms described above.

Singular expressions include plural expressions unless the context clearly indicates an exception.

In each step, the identification code is used for convenience of description, and the identification code does not describe the order of each step. Each of the steps may be performed out of the stated order unless the context clearly dictates the specific order.

Hereinafter, the working principle and embodiments of the disclosure will be described with reference to the accompanying drawings.

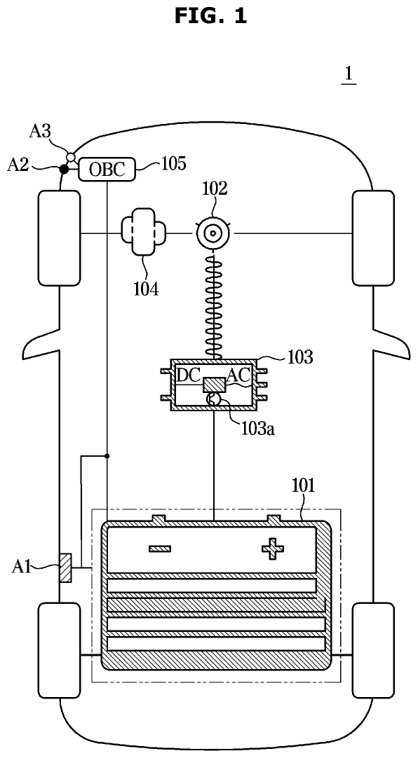

FIG. 1 is a view illustrating a power device of a vehicle according to an embodiment of the disclosure.

A vehicle according to an embodiment is an eco-friendly vehicle that drives using a battery and a motor, and may include an electric vehicle (EV) or a plug-in hybrid electric vehicle (PHEV). In this embodiment, an electric vehicle will be described as an example.

The vehicle 1 includes a body forming an interior and exterior thereof and a chassis in which mechanical devices necessary for driving are installed as remaining parts except for the body.

The exterior of the vehicle body includes a front panel, a bonnet or hood, a roof panel, a rear panel, front, rear, left, and right doors, and windows provided to be opened and closed on the front, rear, left and right doors.

Furthermore, the exterior of the vehicle body includes pillars provided at the boundary between the windows of the front, rear, left, and right doors, a side mirror that provides a driver with a field view of the rear of the vehicle 1, and external lamps that make it easy to see surrounding information while looking ahead and serve a signal and communication function for other vehicles and pedestrians.

The chassis of the vehicle is a frame that supports the body, and the chassis may include wheels arranged on front, rear, left, and right sides of the vehicle, a power device for applying a driving force to the front, rear, left, and right wheels, a steering device, a braking device for applying a braking force to the front, rear, left, and right wheels, and a suspension device.

The power device may include a power generating device and a power transmission device.

In the case of an electric vehicle, the power generating device may include a battery and a motor.

As shown in FIG. 1, the power device of the vehicle 1 includes a battery 101, a motor 102, a motor driver 103, a reducer 104, and a power converter 105 (hereinafter also referred to as an on board charger (OBC)).

The battery 101 may include a plurality of battery cells for charging power.

The battery 101 may include a plurality of battery modules. Furthermore, each battery module may include a plurality of battery cells connected in series and in parallel.

The plurality of battery cells may be collected to form the battery module, and the plurality of battery modules may be collected to form a battery pack.

The battery 101 may supply power for operation to electrical devices such as convenience devices and additional devices provided in the vehicle. The vehicle 1 may further include an auxiliary battery for the above purpose.

Here, an output voltage of a main battery may be the same as an output voltage of an auxiliary battery or may be higher than the output voltage of the auxiliary battery.

When the auxiliary battery is provided in the vehicle, the auxiliary battery may be charged using power charged in the main battery.

The power charged in the battery 101 may also be transmitted to an external device 2.

The motor 102 generates a rotational force using electric energy of the battery 101 and transmits the generated rotational force to the wheels to drive the wheels.

The motor 102 converts the electrical energy of the battery into mechanical energy for operating various devices provided in the vehicle.

When a boot button is turned on, the maximum current is supplied to the motor 102 to generate the maximum torque.

The motor 102 may operate as a generator under energy regeneration conditions by braking, decelerating, downhill driving, or low-speed driving so that the battery 101 is charged.

The motor driver 103 drives the motor 102 in response to a control instruction of a processor 130. The motor driver 103 may include an inverter 103a that converts a battery power into a driving power of the motor 102.

In response to outputting the driving power of the motor 102, the inverter 103a outputs the driving power of the motor 102 based on a target vehicle speed according to a user instruction. Here, the driving power of the motor 102 may vary depending on a switching signal for outputting a current corresponding to the target vehicle speed and a switching signal for outputting a voltage corresponding to the target vehicle speed.

The inverter 103a may transmit power generated from the motor 102 to the battery 101 during regenerative braking. In other words, the inverter includes a plurality of switch elements and may perform a function of changing the direction and output of the current between the motor 102 and the battery 101.

The reducer 104 reduces the speed of the motor 102 and transmits the rotational force obtained by increasing the torque of the motor 102 to the wheels.

The vehicle 1 may further include a charging device provided on the exterior of the vehicle body, to which a fast charging cable or a slow charging cable is connected, and receiving power for charging the battery 101.

The charging device may include a fast charging device A1 for charging the battery 101 at a fast rate and a slow charging device A2 for charging the battery 101 at a slow rate that is slower than the fast charging rate.

A fast charging cable for fast charging may be connected to the fast charging device A1, and a slow charging cable for slow charging may be connected to the slow charging device A2.

Furthermore, the fast charging device A1 for fast charging and the slow charging device A2 for slow charging, which has a slower charging speed than the fast charging, may be provided at the same location on the exterior of the vehicle or may be provided at different locations.

The fast and slow charging devices A1 and A2 may be outlets to which the fast charging cable for charging and the slow charging cable are connected.

The fast charging device A1 may allow an external power source connected to the fast charging cable to be directly connected to the battery 101 of the vehicle. Here, the external power source may supply power of approximately 220V voltage to the vehicle as power from a charging station or a power grid.

Furthermore, in the fast charging cable, a converting device including a converter, an inverter, a high frequency isolation transformer, a rectifier, etc. may be provided. A converting device in the fast charging cable may convert commercial alternating current (AC) power into power for fast charging the battery of the vehicle.

Furthermore, the power source may include a rapid power source and a slow power source.

The rapid power source may supply power of approximately 800V voltage to the vehicle through the rapid cable. In this case, the rapid cable may be used as a means of supplying power of 800V voltage.

The slow power source may supply the power of 220V voltage to the vehicle.

The slow charging device A2 may be an outlet into which a 5-pin connector is inserted and connected or an outlet into which a 7-pin connector is inserted and connected.

If the cable is a 5-pin connector, the 5-pin may include a live pin L1, a neutral pin L2/N, a ground pin GND, a Proximity Detection (PD) pin, and a Control Pilot (CP) pin, which is a control confirmation pin.

When the cable is a 7-pin connector, the 7-pin may further include L2 and L3 pins as a 3-phase AC connector.

The vehicle 1 further includes the OBC 105 that is connected to the slow charging device A2 and converts the external commercial power AC supplied from the slow charging device A2 into rectification and direct current (DC) and transmits to the battery 101. For example, the OBC 105 may include an AC rectifier, Power Factor Correction (PFC), a converter, and a capacitor.

The OBC 105 may further include a filter (not shown) connected to a power source PS to remove noise between the external AC power and the battery 101.

The OBC 105 may be provided with a power transmission device A3 to which a power transmission cable is connected. In other words, the vehicle may supply the power charged in the battery 101 to an external device (i.e., a load) through the power transmission device A3 in a load power supply mode.

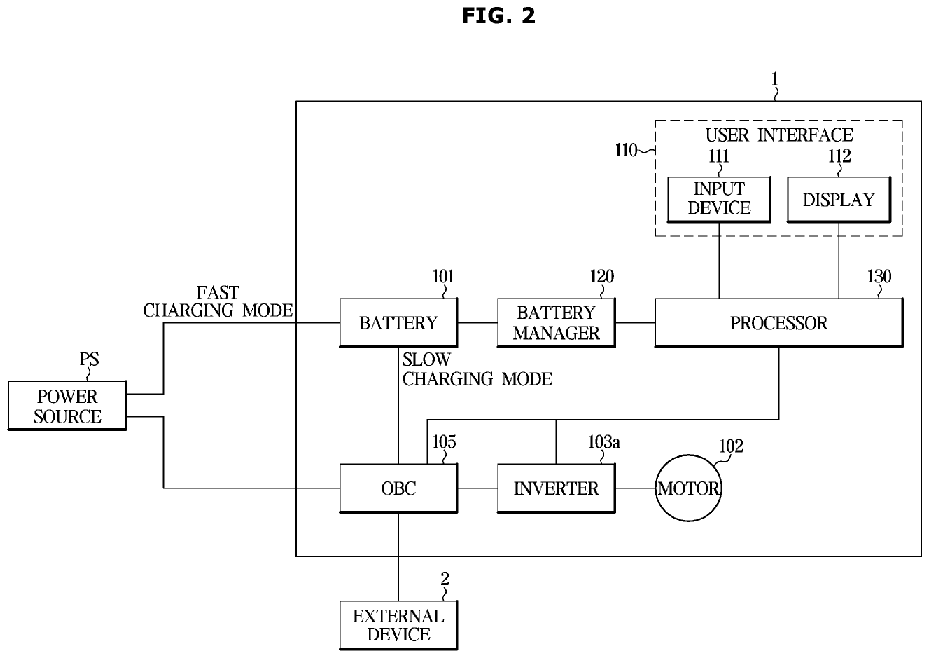

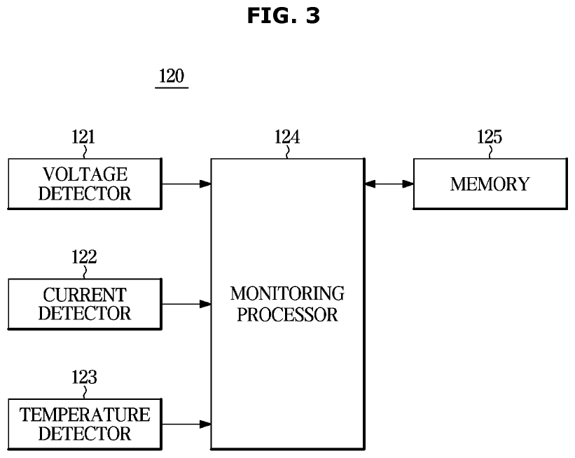

FIG. 2 is a configuration diagram illustrating a power system for transmitting and receiving electric power of a vehicle according to an embodiment of the disclosure, and FIG. 3 is a detailed configuration diagram illustrating a battery manager provided in a vehicle according to an embodiment of the disclosure.

As shown in FIG. 2, the vehicle 1 includes the battery 101, the motor 102, the inverter 103a, the OBC 105, a user interface 110, a battery manager 120, and the processor 130.

The battery 101 may be a battery capable of charging and discharging.

The battery 101 may supply power to the power device including the motor 102.

The battery 101 may be charged using power supplied from the power source PS.

The battery 101 may perform a slow charging mode or a fast charging mode corresponding to the cable connected to the charging device.

The battery 101 may perform fast charging using the power supplied from the power source PS and may perform slow charging using the power converted and transmitted by the OBC 105.

When regenerative braking is performed, the battery 101 may be charged using the power generated by the driven generator.

The battery 101 may supply the power to the external device 2.

The inverter 103a of the motor driver 103 converts the DC voltage of the battery 101 into the AC voltage and applies the converted AC voltage to the motor 102.

In response to outputting the driving power of the motor 102, the inverter 103a outputs driving power of the motor 102 based on the target vehicle speed according to the user instruction. Here, the driving power of the motor 102 may vary depending on the switching signal for outputting the current corresponding to the target vehicle speed and the switching signal for outputting the voltage corresponding to the target vehicle speed.

The inverter 103a transmits regenerative energy of the motor 102 to the battery 101 so that the battery 101 may be charged when the vehicle is braked.

In other words, the inverter 103a may transmit the power generated from the motor 102 to the battery 101 during the regenerative braking.

The inverter 103a includes a plurality of switch elements and may perform a function of changing the direction and output of the current between the motor 102 and the battery 101.

The inverter 103a is connected to the OBC 105, and when the power converted by the OBC 105 is received, the received power is converted into the driving power of the motor 102, and then the converted driving power may be transmitted to the motor 102.

The OBC 105 supplies the battery 101 with a voltage (approximately 800V) of power received through the fast charging cable and the fast charging device A1 in the fast charging mode.

The OBC 105 converts the power supplied from the power source PS into the power for charging the battery 101 in response to performing the slow charging mode and supplies the converted power to the battery 101.

More specifically, when the AC power of the power source PS is received in the slow charging mode, the OBC 105 rectifies the received AC power, boosts the rectified DC power to the DC power suitable for charging the battery 101, and supplies the boosted DC power to the battery 101 so that the battery 101 may be charged.

The OBC 105 may convert the DC power charged in the battery 101 into the DC power having a predetermined amount or more in order to increase the output and efficiency of the motor 102, and then may transmit the converted DC power to the inverter 103a.

The OBC 105 converts the power charged in the battery 101 in response to performing the load power supply mode and supplies the converted power to the external device 2 through the power transmission device A3 and the power transmission cable. In other words, the OBC 105 converts the power of the battery 101 into a power at a level usable by the external device 2.

The OBC 105 may convert a voltage or current of the received power when converting power.

The user interface 110 receives a user input and displays various information on functions performed in the vehicle. The user interface 110 may include an input device 11 and a display 112.

The processor 130 performs overall control in relation to charging the battery, driving the motor, and supplying power to the load. The user interface 110 and the processor 130 will be described later.

The battery manager 120 monitors a charging state, a discharging state, and a failure state of the battery 101.

The battery manager 120 may monitor a state of each battery cell by using the battery cell as a unit, a state of each battery module by using the battery module as a unit, and a state of a battery pack.

As shown in FIG. 3, the battery manager 120 may include a voltage detector 121, a current detector 122, and a temperature detector 123 as a detector that detects a state of charge of the battery to monitor the state of the battery 101.

The battery manager 120 may further include a monitoring processor 124, a memory (i.e., a storage) 125, and a communicator 126.

The voltage detector 121 and the current detector 122 may be detectors that detect an electrical signal for each cell of the battery.

The voltage detector 121 detects a voltage of the battery 101 and outputs a voltage signal corresponding to the detected voltage.

The number of voltage detectors 121 may be plural.

The plurality of voltage detectors 121 may be connected to output terminals of the plurality of battery cells to respectively detect voltages of the plurality of cells.

The plurality of voltage detectors 121 may be connected to output terminals of the plurality of battery modules to respectively detect voltages of the plurality of modules.

The voltage detector 121 may be connected to an output terminal of the battery pack to detect a voltage of the battery pack.

The current detector 122 detects a current of the battery 101 and outputs a current signal corresponding to the detected current.

The number of current detectors 122 may be plural.

The plurality of current detectors 122 may detect currents flowing through the plurality of battery cells, respectively.

The plurality of current detectors 122 may detect currents flowing through the plurality of battery modules, respectively.

The current detector 122 may detect each current flowing through the battery pack. Here, the battery pack may refer to a battery in the embodiment.

The temperature detector 123 detects a temperature of the battery 101 and outputs a temperature signal for the detected temperature. The temperature detector 123 may be provided inside the battery pack.

The number of temperature detectors 123 may be plural.

The plurality of temperature detectors 123 may be provided in each of the plurality of battery cells and may detect temperatures of the plurality of battery cells, respectively.

The plurality of temperature detectors 123 may be provided in each of the plurality of battery modules and may detect temperatures of the plurality of battery modules, respectively.

The temperature detector 123 may be provided in the battery pack and detect the temperature of the battery pack.

The monitoring processor 124 monitors the state of charge of the battery 101 based on the detected current of the battery 101.

The monitoring processor 124 may monitor the state of charge of the battery based on the detected current and voltage of the battery 101.

The monitoring processor 124 may monitor a state of charge (SOC) of the battery based on the current, voltage, and temperature of each cell of the battery.

Here, the SOC of the battery 101 may include an amount of charge of the battery 101.

In other words, the monitoring processor 124 may obtain the SOC of the battery corresponding to the current, voltage, and temperature of the battery from a pre-stored table. In the pre-stored table, the amount of charge of the battery corresponding to a correlation between the current, voltage, and temperature of the battery may be matched.

In response to a boot-on instruction being received from the processor 130, the monitoring processor 124 identifies the SOC of the battery and transmits a SOC information on the SOC of the battery to the processor 130.

The monitoring processor 124 may determine a thermal runaway based on temperature information detected by the temperature detector 123.

In response to determining that the state of the battery is a thermal runaway state, the monitoring processor 124 controls a driving of a fan (not shown) so that the fan rotates at the maximum rotation speed. As a result, the gas generated from the battery 101 may be discharged to the outside.

The monitoring processor 124 may be implemented by a memory (not shown) that stores data for algorithms or programs that reproduces an algorithm for controlling operation of the components in the battery manager 120 and a processor (not shown) that performs the above-described operation using the data stored in the memory. In this case, the memory and the processor may be implemented as separate chips. Alternatively, the memory and the processor may be implemented as a single chip.

The memory 125 may store a table in which the state of charge of the battery corresponding to the correlation between current, voltage, and temperature of the battery is matched.

The memory 125 may store a table in which the amount of the charge of the battery corresponding to the correlation between a current, a voltage, and a temperature of the battery is matched.

The memory 125 may be implemented as at least one of a nonvolatile memory device such as cache, read only memory (ROM), programmable ROM (PROM), erasable programmable ROM (EPROM), electrically erasable programmable ROM (EEPROM), and flash memory, or a volatile memory device such as random access memory (RAM), or a storage medium such as hard disk drive (HDD) and CD-ROM, but is not limited thereto.

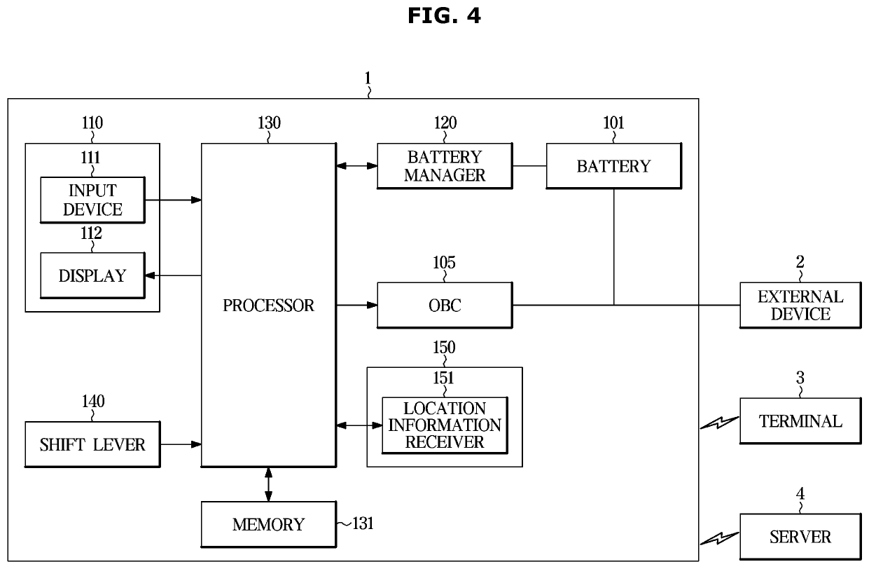

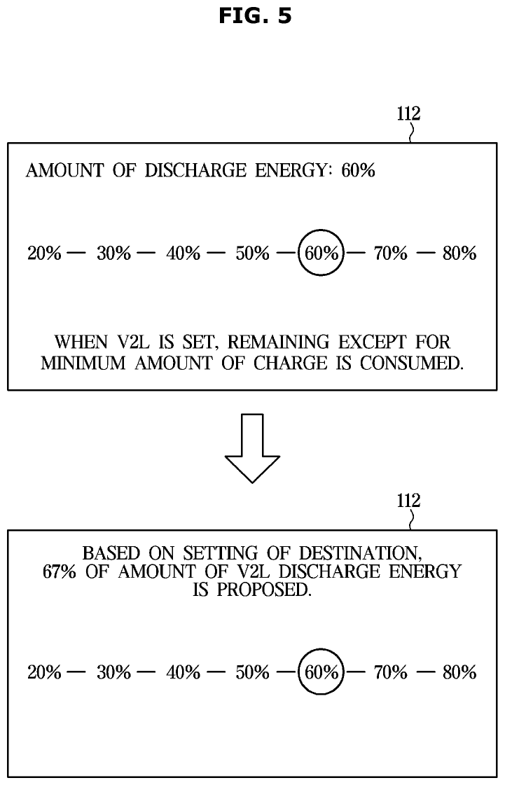

FIG. 4 is a view illustrating a control configuration of a vehicle according to an embodiment of the disclosure, which will be described with reference to FIG. 5.

The vehicle 1 includes the battery 101, the OBC 105, the user interface 110, the battery manager 120, the processor 130, a memory 131, a shift lever 140, and a communicator 150.

The battery 101, the OBC 105, and the battery manager 120 have been described with reference to FIGS. 1 and 2, so a description thereof will be omitted.

The user interface 110 may be an Audio Video Navigation (AVN) device that performs a user audio function, a video function, and a navigation function. The user interface 110 may further perform at least one of a broadcasting function (e.g., a Digital Multimedia Broadcasting (DMB) function), a radio function, a content playback function, and an Internet search function.

The user interface 110 displays an image for at least one function selected by the user.

The user interface 110 may receive a user input. The user interface 110 may include the input device in and the display 112.

The input device in receives an on/off instruction of at least one function among a plurality of functions that may be performed in the vehicle and receives an operation instruction for the input of at least one function.

The input device in may receive the on/off instruction of the fast charging mode and the on/off instruction of the slow charging mode and may also receive the on/off instruction of the load power supply mode.

The input device in may receive a target charge amount in the fast charging mode or the slow charging mode.

The input device in may receive identification information of the load and a required amount of power of the load in the load power supply mode.

The input device 111 may receive an on/off instruction of a navigation mode and destination information.

The input device 111 may receive an on/off instruction of a utility mode.

Here, the utility mode refers to a mode for supplying the power of the battery to convenient devices for convenience of a user such as an air conditioner, a user interface, a heater, an audio device, and a radio device, and the like, in a state in which power of the battery is not supplied to the motor 102.

The input device 111 may receive identification information of a terminal 3 and receive a communication connection instruction with the terminal 3.

The input device 111 may also receive a selection instruction for any one of the plurality of charging stations.

The input device 111 may receive an acceptance or rejection instruction for setting an amount of a selected discharge energy proposed by the processor 130 to an amount of limited energy.

The input device 111 may receive information on an amount of discharge energy selected by the user.

The input device 111 may include a hardware device such as various buttons or switches, a pedal, a keyboard, a mouse, a track-ball, various levers, a handle, or a stick.

Furthermore, the input device 111 may include a graphical user interface (GUI) such as a touch panel, that is, a software device. The touch panel may be implemented as a touch screen panel (TSP) to form a layer structure with the display 112.

The display 112 displays operation information for a function being performed.

The display 112 may display on/off information of the fast charging mode, on/off information of the slow charging mode, on/off information of the load power supply mode, and on/off information of the utility mode.

The display 112 may also display charge state information of the battery 101. The charge state information of the battery 101 may include the amount of charge of the battery and a charge level corresponding to the amount of charge of the battery.

The display 112 may display guide information regarding the load power supply mode.

The display 112 displays identification information of the external device 2 in the load power supply mode and may display the required amount of power of the external device 2 and may further display information on a supply time required for supplying power to the external device.

The display 112 may display information on a proposed amount of discharge energy corresponding to the control signal of the processor 130 and may display information on the amount of discharge energy selected by the user. Here, the amount of discharge energy is an amount of energy to be supplied to an external device.

The display 112 may display a charging time required for charging to the maximum amount of charge in the fast charging mode or the slow charging mode and may display the required amount of power and the charging time required to reach the destination.

The display 112 may display communication possible or impossible information with the terminal 3, may display identification information of the terminal 3 capable of communication, and may further display event information and destination information obtained from the terminal 3.

The display 112 may display location information of a plurality of charging stations or display identification information of the plurality of charging stations in response to the control instruction of the processor 130.

The display 112 may display price information and charging time information of the charging station selected by the user.

The display 112 may be provided as a cathode ray tube (CRT), a digital light processing (DLP) panel, a plasma display panel (PDP), a liquid crystal display (LCD) panel, an electroluminescence (EL) panel, an electrophoretic display (EPD) panel, an electro chromic display (ECD) panel, a light emitting diode (LED) panel, or an organic light emitting diode (OLED) panel, but is not limited thereto.

The vehicle may further include a sound outputter (not shown) for outputting various types of information regarding a start of battery charging, a completion of charging of the battery, a start of power supply of an external device, and a completion of power supply of the external device, as sound.

The sound outputter may include one or more speakers.

The processor 130 controls the inverter 103a to drive the motor 102, thereby performing the traveling of the vehicle.

The processor 130 may control operation of the display 112 to output state information on abnormal and normal states of the battery transmitted from the battery manager 120 and may also control operation of the sound outputter (not shown) to output the state information of the battery.

The processor 130 receives the information on the SOC of the battery from the battery manager 120, determines whether charging of the battery 101 is necessary based on the received information on the SOC, and controls the display 112 to output information necessary for charging of the battery 101 in response to determining that the battery 101 needs to be charged. Here, the information on the SOC of the battery may include the amount of charge of the battery.

In response to a fast charging instruction or a slow charging instruction of the battery being received through the input device 11, the processor 130 may control the display 112 to display the information on the SOC for a current charging state of the battery and may obtain the target charge amount based on the information on the SOC and control the display 112 to display information on the obtained target charge amount.

The processor 130 may control the operation of the OBC 105 in response to the slow charging instruction.

The processor 130 may control the supply of charged power to the battery 101 in response to an on instruction of the load power supply mode. In this case, the processor 130 may control the operation of the OBC 105 in response to the on instruction of the load power supply mode.

In response to the on instruction of the load power supply mode and the information on the required amount of power being received, the processor 130 determines whether the load power supply mode may be executed based on current information on the SOC of the battery. The processor may control the display 112 to display information on the execution of the load power supply mode being unavailable in response to determining that the execution of the load power supply mode is unavailable and may control the display 112 to display information on the execution of the load power supply mode being available in response to determining that the execution of the load power supply mode is available.

For example, in response to the on instruction of the load power supply mode and the information on the required amount of power being received, the processor 130 identifies a current charge amount of the battery and controls the display 112 to display the information on the execution of the load power supply mode being unavailable in response to the identified charge amount being less than a predetermined reference charge amount.

In response to the on instruction of the load power supply mode and the information on the required amount of power being received, the processor 130 determines whether the power transmission cable is connected to the power transmission device A3 and transmits the power charged in the battery to the external device 2 through the power transmission device A3 in response to determining that the power transmission device A3 is connected to the power transmission cable.

In this case, the processor 130 may control the OBC 105 to convert the voltage of the power of the battery 101 and may transmit the converted power to the external device 2 through the power transmission device A3 and the power transmission cable.

In response to determining that the power transmission cable is connected to the power transmission device A3, the processor 130 identifies the information on the required amount of power to be supplied to the external device 2 received by the input device 11.

In response to the on instruction of the load power supply mode being received, the processor 130 determines whether the load power supply mode may be executed.

The processor 130 determines whether the shift lever 140 is positioned at the parking stage P based on manipulation position information of the shift lever 140 and determines that the load power supply mode may be executed in response to determining that the shift lever 140 is positioned at the parking stage P.

In response to determining that the on instruction of a parking button (a side brake lever (not shown)) for operating the parking brake device is received, the processor 130 determines that the load power supply mode may be executed.

The processor 130 determines whether the on instruction of the utility mode is received through the input device 11 and determines that the load power supply mode may be executed in response to determining that the on instruction of the utility mode is received.

In response to determining that the load power supply mode may be executed, the processor 130 may control the display 112 to display destination input request information for requesting input of the destination information.

In response to the destination information being received through the input device 111, the processor 130 identifies current location information, searches for a route from the current location to the destination based on the current location information and the destination information, and obtains distance information on the distance from the current location to the destination based on the searched route.

The processor 130 identifies information on types of roads in the searched route, obtains fuel efficiency information corresponding to the information on the types of roads, identifies the required amount of power necessary for reaching the destination based on the obtained distance information and the fuel efficiency information for each type of road, obtains the amount of discharge energy based on the identified required amount of power, the current charge amount, and a predetermined amount of margin power, and controls the display 112 to display proposal information for suggesting setting of the obtained amount of discharge energy as a discharge limit amount. Here, the obtained amount of discharge energy is the amount of discharge energy proposed by the processor.

As shown in FIG. 5, the display 112 displays the amount of discharge energy currently set in response to the control instruction of the processor 130 and may display the amount of discharge energy proposed by the processor 150 based on the destination information after the on instruction of the load power supply mode and destination information are input. Accordingly, the user may select the amount of energy to be supplied to the external device.

In response to a plurality of routes being found, the processor 130 may control the display 112 to display route selection request information for requesting the user to select one of the plurality of routes.

In response to determining that the destination information has not been received through the input device 11, the processor 130 attempts communication with the terminal 3, and in response to determining that communication with the terminal 3 is performed, the processor 130 requests event information from the terminal 3.

In response to the event information being received from the terminal 3, the processor 130 identifies the destination information corresponding to the received event information, identifies the current location information, searches for a route from the current location to the destination based on the current location information and the destination information, and obtains the distance information on the distance from the current location to the destination based on the searched route.

The processor 130 may receive contact information and event information from the terminal and may obtain the destination information based on the received contact information and the event information.

The processor 130 may also obtain the destination information through an Internet search based on the event information.

The processor 130 compares the selected amount of discharge energy through the input device 11 with the proposed amount of discharge energy and supplies the power to the external device 2 by the proposed amount of discharge energy among the amount of power charged in the battery in response to determining that the selected amount of discharge energy is the proposed amount of discharge energy.

In response to determining that the amount of discharge energy selected through the input device 11 is smaller than the proposed amount of discharge energy, the processor 130 supplies the power to the external device 2 by the selected amount of discharge energy from among the amount of power charged in the battery.

In response to determining that the amount of discharge energy selected through the input device 111 is greater than the proposed amount of discharge energy, the processor 130 supplies the power to the external device 2 by the selected amount of discharge energy among the amount of power charged in the battery, searches for a charging station based on the route information, and adds the searched charging station as a waypoint based on the location information of the searched charging station.

The processor 130 may search for a charging station based on a difference value between the proposed amount of discharge energy and the selected energy, the route information, the information on the types of roads in the route, and the fuel efficiency information for each type of road, and may add the searched charging station as a waypoint based on the location information of the searched charging station.

The processor 130 may also suggest charging at the searched charging station.

The processor 130 may obtain arrival time information to arrive at the charging station based on the searched location information and the current location information and may transmit identification information and reservation information of the vehicle to the charging station based on the obtained arrival time information.

When a plurality of charging stations are found, the processor 130 may control the display 112 to display the location information, the identification information, and the price information of the plurality of charging stations, and add the selected charging station as a waypoint based on the location information of the charging station selected through the input device 11.

The processor 130 controls the termination of the load power supply mode when the energy supplied to the external device becomes the selected amount of discharge energy while the load power supply mode is being performed.

The processor 130 may obtain the information on the type of road from map information for every drive and may identify the amount of power consumed, obtain the fuel efficiency for each type of road based on the type of road and the amount of power consumed and store the obtained fuel efficiency for each type of road, and update the pre-stored fuel efficiency for each type of road.

The processor 130 may obtain fuel efficiency information based on vehicle stop information, weight information, driving distance information, and driving habit information.

The processor 130 may communicate with a server 4 to transmit the identification information of the vehicle to the server 4, receive big data of other vehicles of the same vehicle type from the server, and obtain and store the fuel efficiency information for each type of road from the received big data.

The server 4 may receive road location information and the fuel efficiency information for each type of road from a plurality of vehicles, store the road location information and the fuel efficiency information for each type of road from the received plurality of vehicles as big data, and provide the big data in response to a request of the vehicle.

The processor 130 may be implemented by a memory (not shown) that stores data for algorithms or programs that reproduces an algorithm for controlling operation of the components in the vehicle 1 and a processor (not shown) that performs the above-described operation using the data stored in the memory. In this case, the memory and the processor may be implemented as separate chips. Alternatively, the memory and the processor may be implemented as a single chip.

The memory 131 stores the fuel efficiency information for each type of road.

The memory 131 may store the map information and type information for each road of the map.

The memory 131 may store big data.

The memory 131 may store information on the predetermined margin amount of power.

The memory 131 may be implemented as at least one of a nonvolatile memory device such as cache, ROM, PROM, EPROM, EEPROM, and flash memory, or a volatile memory device such as RAM, or a storage medium such as HDD and CD-ROM, but is not limited thereto.

The shift lever 140 receives a manipulation instruction for at least one of a drive stage D, a parking stage P, a reverse stage R, and a neutral stage N, and transmits the manipulation position information for the received manipulation instruction to the processor 130.

The vehicle further includes the parking button (e.g., an electric parking brake (EPB) button) positioned around the shift lever and receiving an operation instruction of the EPB device (not shown). Furthermore, according to an embodiment of the vehicle, the vehicle may be provided with a side brake lever instead of a parking button.

The vehicle may further include a lever position detector (not shown) for detecting the manipulation position of the shift lever 140, and may further include a lever signal receiver (not illustrated) for receiving the manipulation position information and transmitting the manipulation position information to the processor 130.

The communicator 150 performs communication between the processor 130 and the battery manager 120.

The communicator 150 may include one or more components that enable communication between the processor 130 and the battery manager 120, for example, at least one of a short-range communication module, a wired communication module, and a wireless communication module.

The short-distance communication module may include various short-distance communication modules for transmitting and receiving signals using a wireless communication network in a short distance such as a Bluetooth module, an infrared communication module, a Radio Frequency Identification (RFID) communication module, a Wireless Local Access Network (WLAN) communication module, a Near Field Communication (NFC) module, and a Zigbee communication module, and the like.

The wired communication module may include a variety of wired communication modules such as a Controller Area Network (CAN) communication module, a Local Area Network (LAN) module, a Wide Area Network (WAN) module, or a Value Added Network (VAN) module, and the like, and various cable communications such as Universal Serial Bus (USB), High Definition Multimedia Interface (HDMI), Digital Visual Interface (DVI), Recommended Standard 232 (RS-232), power line communication, and Plain Old Telephone Service (POTS), and the like.

The wireless communication module may include a wireless communication module supporting various wireless communication methods such as a Wireless Fidelity (Wifi) module, a Wireless Broadband (WiBro) module, Global System for Mobile Communication (GSM), Code Division Multiple Access (CDMA), Wideband Code Division Multiple Access (WCDMA), Universal Mobile Telecommunications System (UMTS), Time Division Multiple Access (TDMA), Long Term Evolution (LTE), and Ultra Wide Band (UWB), and the like.

The communicator 150 includes a location information receiver 151 that receives location information for recognizing the current location of the vehicle.

The location information receiver 151 may be a Global Positioning System (GPS) receiver that communicates with a plurality of satellites. Here, the GPS receiver may include an antenna module for receiving signals from a plurality of GPS satellites and may further include a software for obtaining a current position by using distance and time information corresponding to position signals of the plurality of GPS satellites and an outputter for outputting the obtained location information of the vehicle.

The communicator 150 communicates with the terminal 3 carried by a user and the server 4.

The terminal 3 may be implemented as a computer or a portable terminal that may be connected to the vehicle via a network. Herein, the computer includes, for example, a notebook equipped with a web browser, a desktop, a laptop, a tablet personal computer (PC), a slate PC, and the like. The portable terminal includes, as a wireless communication device that ensures portability and mobility, for example, all kinds of handheld-based wireless communication devices including Personal Communication System (PCS), Global System for Mobile (GSM) communications, Personal Digital Cellular (PDC), Personal Handyphone System (PHS), Personal Digital Assistant (PDA), International Mobile Telecommunication (IMT)-2000, CDMA-2000, W-CDMA, WiBro terminals, and the like, and wearable devices such as smart phones, rings, bracelets, anklets, necklaces, glasses, contact lenses, or head-mounted-devices (HMDs) and the like.

The terminal 3 may store the event information including schedule information of the user.

The event information may be information input by the user.

The terminal 3 may store the destination information corresponding to the event information or may store related party information corresponding to the event information.

For example, when the event information is ‘Visit to Company H’, the terminal 3 may obtain the location information of ‘Company H’ and obtain the acquired location information of ‘Company H’ as destination information.

The terminal 3 may also obtain the destination information from the related party information. For example, when the event information is ‘Meeting with Researcher X of Company H’, the terminal 3 may obtain the location information of ‘Company H’ where ‘Researcher X’ works from the information of Researcher X and obtain the acquired location information of ‘Company H’ as destination information.

The terminal 3 may obtain the destination information for the related party information based on the contact information that is pre-stored.

When the terminal 3 transmits the event information to the vehicle, it is also possible to obtain the destination information based on the event information in the vehicle.

At least one component may be added or deleted according to the performance of the components of the vehicle shown in FIGS. 2 and 4. Furthermore, it will be readily understood by those skilled in the art that the mutual positions of the components may be changed corresponding to the performance or structure of the system.

Meanwhile, each component shown in FIGS. 2 and 4 refers to software and/or hardware components such as a Field Programmable Gate Array (FPGA) and an Application Specific Integrated Circuit (ASIC).

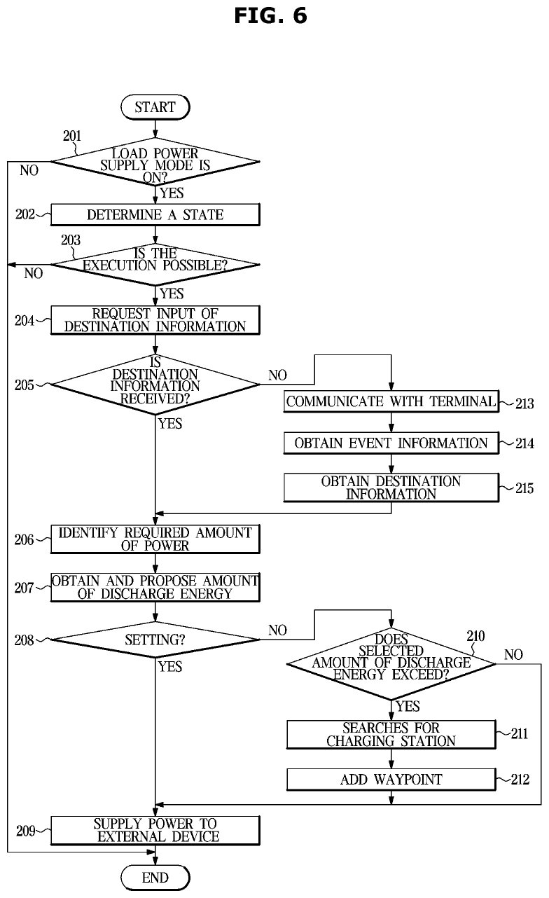

FIG. 6 is a control flowchart illustrating control of a vehicle according to an exemplary embodiment of the disclosure.

The vehicle determines whether the on instruction of the load power supply mode and the information on the required amount of power is received (201) and determines whether the load power supply mode may be executed in response to determining that the on instruction of the load power supply mode and the information on the required amount of power has been received (202).

The vehicle determines whether the shift lever 140 is positioned at the parking stage P based on the manipulation position information of the shift lever 140 and determines that the load power supply mode may be executed in response to determining that the shift lever 140 is positioned at the parking stage P.

In response to determining that the on instruction of the parking button (side brake lever (not shown)) for operating the parking brake device is received, the vehicle determines that the load power supply mode may be executed.

The vehicle determines whether the on instruction of the utility mode is received through the input device 111 and determines that the load power supply mode may be executed in response to determining that the on instruction of the utility mode is received.

In response to determining that the load power supply mode may be executed (YES to 203), the vehicle requests the input of destination information (204). In this case, the vehicle may display the destination input request information on the display 112 when the destination information is requested to be input.

In response to the destination information being received through the input device 11 (YES to 205), the vehicle identifies the current location information, searches for a route from the current location to the destination based on the current location information and the destination information, obtains the distance information on the distance from the current location to the destination based on the searched route, and identifies the required amount of power based on the obtained distance information (206).

More specifically, the vehicle identifies information on types of roads in the searched route, obtains fuel efficiency information corresponding to the information on the types of roads, and identifies the required amount of power necessary for reaching the destination based on the obtained distance information and the fuel efficiency information for each type of road.

The vehicle classifies the roads in the searched route based on the types, obtains the distance information and the fuel efficiency information for each type of classified road, and identifies the required amount of power necessary for reaching the destination based on the distance information and the fuel efficiency information for each type of classified road.

The vehicle may communicate with the server (not shown) to transmit the identification information of the vehicle to the server, receive big data of other vehicles of the same vehicle type as the vehicle from the server, and obtain the fuel efficiency information for each type of road in the searched route from the received big data.

The vehicle obtains the amount of discharge energy based on the identified required amount of power, the current charge amount (refers to the amount of power charged in the battery), and the predetermined amount of margin power, and proposes to set the obtained amount of discharge energy as the discharge limit amount (207). In other words, the vehicle may display the proposal information for suggesting setting of the obtained amount of discharge energy through the display 112. Here, the obtained amount of discharge energy is the amount of discharge energy proposed by the processor.

The vehicle may display information on the amount of discharge energy that may be supplied to an external device, display a text requesting of the user whether to set the proposed discharge energy as the discharge limit amount, and display an accept button and a reject button.

The vehicle may display a text requesting input of the amount of discharge energy desired by the user in response to a selection signal of the reject button and may also display the required amount of power of the external device.

The vehicle determines whether the discharge limit amount is set as the proposed amount of discharge energy (208) and supplies the power to an external device in response to determining that the discharge limit amount is set as the proposed amount of discharge energy (209).

Determining whether the discharge limit amount is set as the proposed amount of discharge energy may include determining whether the amount of discharge energy selected by the user through the input device is the same as the proposed amount of discharge energy.

Determining whether the discharge limit amount is set as the proposed amount of discharge energy may include determining whether an acceptance instruction or a rejection instruction for setting of the proposed amount of discharge energy is received.

At this time, the vehicle determines whether the power transmission device A3 is connected to the power transmission cable, and in response to determining that the power transmission device A3 is connected to the power transmission cable, the vehicle transmits the power charged in the battery 101 to the external device 2 through the power transmission device A3.

In response to determining that the discharge limit amount is not set as the proposed amount of discharge energy (NO to S208), the vehicle identifies the amount of discharge energy selected by the user through the input device 111.

The vehicle determines whether the selected amount of discharge energy exceeds the proposed amount of discharge energy (210).

In response to determining that the selected amount of discharge energy does not exceed the proposed amount of discharge energy (NO to S210), the vehicle transmits the power charged in the battery 101 to the external device 2 through the power transmission device A3 in response to determining that the selected amount of discharge energy is less than the proposed amount of discharge energy.

In response to determining that the selected amount of discharge energy exceeds the proposed amount of discharge energy (YES to S210), the vehicle searches for a charging station presenting in the route based on the route information (211) and adds the searched charging station as a waypoint (212).

The vehicle then supplies the power of the battery to the external device 2 by the selected amount of discharge energy.

In response to determining that the selected amount of discharge energy exceeds the proposed amount of discharging energy, the vehicle searches for charging stations existing in the route based on the current location information, the remaining battery charge information after the termination of the load power supply mode, and the route information.

The vehicle may obtain arrival time information to arrive at the charging station based on the searched location information and the current location information of the charging station and may transmit the identification information and reservation information of the vehicle to the charging station based on the obtained arrival time information.

The vehicle may also display search notification information for notifying of the search for a charging station and location information and identification information for the found charging station.

The vehicle may also display selection request information for requesting selection of one of the plurality of charging stations through the display.

In response to determining that the destination information has not been received through the input device 111 (NO to S205), the vehicle attempts to communicate with the terminal 3 (213) and requests the event information from the terminal 3 in response to determining that communication with the terminal 3 is performed.

The vehicle may obtain the event information from the terminal (214).

The vehicle may obtain the destination information corresponding to the event information (215), identify the current location information, search for a route from the current location to the destination based on the current location information and the destination information, and obtain the distance information from the current location to the destination based on the searched route.

The vehicle terminates the load power supply mode when the amount of energy for the power supplied to the external device 2 becomes the selected amount of discharge energy while the load power supply mode is being performed.

The vehicle may obtain the information on the type of road from the map information for every drive and may identify the amount of power consumed, obtain the fuel efficiency for each type of road based on the type of road and the amount of power consumed and store the obtained fuel efficiency for each type of road, and update the pre-stored fuel efficiency for each type of road.

The vehicle may obtain the fuel efficiency information by identifying the amount of power consumed whenever the vehicle travels a reference distance. The reference distance may be approximately 50 km.

The vehicle may calculate an average of fuel efficiency for each reference distance and obtain the fuel efficiency information using the calculated average.

As is apparent from the above, embodiments of the disclosure may propose the amount of discharge energy to be supplied to the load based on the destination information when the load power supply is executed, so that the user sets the proposed amount of discharge energy as the amount of limited energy, thereby securing the driving distance to the destination and thus solving anxiety of the user.

The embodiments of the disclosure may improve user convenience by obtaining the destination information based on the event information of the terminal and proposing the amount of discharge energy to be supplied to the load based on the destination information when the destination information does not exist during the load power supply mode.

As such, the embodiments of the disclosure may safely drive to the destination using the power remaining in the battery after supplying the power to an external device through the load power supply mode, thereby improving driving stability.

The embodiments of the disclosure, when the amount of discharge energy selected by the user is greater than the proposed amount of discharge energy, determines that the user's intention has a greater weight in the load power supply than the traveling to the destination, and allows the load power supply to be preferentially performed, thereby improving user satisfaction.

The embodiments of the disclosure, when the amount of discharge energy selected by the user is greater than the proposed amount of discharge energy, may stably charge the vehicle by searching for a charging station existing in the route to the destination and adding the searched charging station as a waypoint, thereby giving the user a sense of security.

The embodiments of the disclosure may be economical and improve the utility of the power supply mode of battery because of performing a stable load power supply mode without a separate sensor and device.

The embodiments of the disclosure may increase the convenience of users who use the eco-friendly vehicles by supplying the power from the vehicle's battery to the external device, and may increase the sales volume and usage amount of the eco-friendly vehicles due to the increase in the convenience of the eco-friendly vehicles. As a result, environmental pollution caused by vehicles may be reduced.

As described above, the embodiments of the disclosure may improve quality and marketability of the eco-friendly vehicles, further increase user satisfaction, improve vehicle safety, and secure product competitiveness.

On the other hand, the exemplary embodiments of the disclosure may be embodied in the form of a recording medium storing instructions executable by a computer. The instructions may be stored in the form of program code and, when executed by a processor, may generate a program module to perform the operations of the exemplary embodiments. The recording medium may be embodied as a non-transitory computer-readable recording medium.

The non-transitory computer-readable recording medium includes all types of recording media in which instructions which may be decoded by a computer are stored, for example, a Read Only Memory (ROM), a Random Access Memory (RAM), a magnetic tape, a magnetic disk, a flash memory, an optical data storage device, and the like.

Although exemplary embodiments of the disclosure have been described for illustrative purposes, those skilled in the art will appreciate that various modifications, additions and substitutions are possible, without departing from the scope and spirit of the disclosure. Therefore, exemplary embodiments of the present disclosure have not been described for limiting purposes.

What is claimed is:

1. A vehicle comprising:
a battery;
an input device;
a display; and
a processor configured to:
request input of destination information in response to receipt of an on instruction of a load power supply mode through the input device;
obtain distance information from a current location to a destination based on current location information and the destination information in response to receipt of the destination information through the input device;
obtain a required amount of power necessary for driving to the destination based on the obtained distance information;
identify an amount of power charged in the battery;
obtain an amount of discharge energy by supplying power to an external device based on the obtained required amount of power and the amount of power charged in the battery; and
control the display to display the obtained amount of discharge energy as proposal information.

2. The vehicle of claim 1, further comprising:
a power transmission device to which a power transmission cable is connected; and
an on board charger configured to convert a level of power of the battery and transmit the converted level of power to the power transmission device.

3. The vehicle of claim 1, wherein the processor is further configured to determine whether the power may be supplied to the external device based on manipulation position information of a shift lever or mode information received through the input device, in response to receipt of the on instruction of the load power supply mode through the input device.

4. The vehicle of claim 3, wherein the processor is further configured to determine that the load power supply mode may be executed in response to a determination that the shift lever is positioned at a parking stage P based on the manipulation position information of the shift lever.

5. The vehicle of claim 3, wherein the processor is further configured to determine that the load power supply mode may be executed in response to a determination that an on instruction of a utility mode is received through the input device.

6. The vehicle of claim 5, wherein the processor is further configured to control the display to display destination input request information for requesting the input of the destination information in response to a determination that the load power supply mode may be executed.

7. The vehicle of claim 1, wherein the processor is further configured to:
search for a route based on the current location information and the destination information;
obtain distance information and fuel efficiency information for each type of road in the searched route based on route information on the searched route; and
obtain the required amount of power based on the distance information and fuel efficiency information for each type of road in the searched route.

8. The vehicle of claim 7, further comprising a communicator, wherein the processor is further configured to:
receive big data from a server through the communicator;
obtain the fuel efficiency information in the searched route based on the received big data; and
obtain the required amount of power based on the obtained fuel efficiency information.

9. The vehicle of claim 1, wherein the processor is further configured to use a predetermined amount of margin power when obtaining the amount of discharge energy.

10. The vehicle of claim 1, further comprising a communicator, wherein the processor is configured to:
in response to a determination that the destination information has not been received through the input device, attempt to communicate with a terminal through the communicator; and
in response to communication with the terminal being performed, obtain event information from the terminal and obtain the destination information based on the obtained event information.

11. The vehicle of claim 1, wherein the processor is further configured to:
in response to the amount of discharge energy received in the input device exceeding the obtained amount of discharge energy, search for a charging station based on the current location information and the destination information; and
add the searched charging station as a waypoint.

12. The vehicle of claim 11, wherein the processor is further configured to:
identify an amount of energy supplied to the external device; and
control termination of the load power supply mode in response to the identified amount of energy being the obtained amount of discharge energy.

13. The vehicle of claim 1, wherein the processor is further configured to, in response to determining that the obtained amount of discharge energy is set as the amount of energy to be supplied to the external device, control termination of the load power supply mode when the amount of energy supplied to the external device becomes the obtained amount of discharge energy.

14. A method of controlling a vehicle that comprises a motor for generating a driving force by receiving power from a battery, the method comprising:
requesting input of destination information in response to receiving an on instruction of a load power supply mode through an input device;
obtaining distance information from a current location to a destination based on current location information and the destination information in response to receiving the destination information through the input device;
obtaining a required amount of power necessary for driving to the destination based on the obtained distance information;
identifying an amount of power charged in the battery;
obtaining an amount of discharge energy by supplying power to an external device based on the obtained required amount of power, the amount of power charged in the battery, and a predetermined amount of margin power; and
displaying the obtained amount of discharge energy as proposed information on a display.

15. The method of claim 14, further comprising:
determining that the load power supply mode may be executed in response to determining that a shift lever is positioned at a parking stage P based on manipulation position information of the shift lever; and
displaying destination input request information for requesting the input of the destination information on the display in response to determining that the load power supply mode may be executed.

16. The method of claim 14, wherein obtaining the required amount of power further comprises:
searching for a route based on the current location information and the destination information;
obtaining distance information and fuel efficiency information for each type of road in the searched route based on route information on the searched route; and
obtaining the required amount of power based on the distance information and fuel efficiency information for each type of road in the searched route.

17. The method of claim 14, wherein obtaining the required amount of power further comprises:
searching for a route based on the current location information and the destination information;
receiving big data from a server through a communicator;
obtaining fuel efficiency information in the searched route based on the received big data; and
obtaining the required amount of power based on the obtained fuel efficiency information.

18. The method of claim 14, further comprising:
attempting to communicate with a terminal through a communicator in response to determining that the destination information has not been received through the input device;
obtaining event information from the terminal in response to communication with the terminal being performed; and
obtaining the destination information based on the obtained event information.

19. The method of claim 14, further comprising:
in response to the amount of discharge energy received in the input device exceeding the obtained amount of discharge energy, searching for a charging station based on the current location information and the destination information; and
adding the searched charging station as a waypoint.

20. The method of claim 14, further comprising:
identifying an amount of energy supplied to the external device; and
controlling termination of the load power supply mode in response to the identified amount of energy being the obtained amount of discharge energy.
